(19) United States
(12) Patent Application Publication
(10) Pub. No.: US 2018/0161999 A1
(43) Pub. Date: Jun. 14, 2018

(54) RAZOR BLADE ASSEMBLY

(71) Applicant: Amir DEPAZ, Poughkeepsie, NY (US)

(72) Inventor: Amir DEPAZ, Poughkeepsie, NY (US)

(21) Appl. No.: 15/574,918

(22) PCT Filed: Jun. 24, 2015
(86) PCT No.: PCT/IB2015/001048

§ 371 Date: Nov. 17, 2017

(51) Int. Cl. B26B 21/56; B26B 21/22; B26B 21/40; B26B 21/52

(52) U.S. Cl. CPC B26B 21/565; B26B 21/22; B26B 21/4068; B26B 21/521; B26B 21/4012

(57) ABSTRACT

Razor blade assembly (100), comprising in sequence an upper plate (110) with a radius of curvature RU; a first razor blade (120) of the thickness T1; a curved spacer member (130) with a radius of curvature RS; a second razor blade (140) of the thickness T2; and a lower plate (150) having a radius of curvature RL, wherein these elements can be reversibly assembled and mounted vertically in height on a razor handle (160); the first razor blade (120) and the second razor blade (140) have a generally rectangular shape and comprise a front cutting edge (121a, 141a) and a rear cutting edge (121b, 141b) running lengthwise; the first and second razor blades (120,140) in its unloaded state are curved in a cross-sectional plane orthogonal to the cutting edges; and the thickness T1 and T2 of the first and second razor blades (120,140) is at least 0.45 mm, and preferably at least 0.50 mm.

### BACKGROUND OF THE INVENTION

### 1. Field of the Invention

The invention relates to a razor blade assembly according to the preamble of claim 1 and to a razor blade for a razor blade assembly according to the preamble of claim 18.

### 2. Description of the Related Art

A conventional razor blade assembly is known from U.S. Pat. No. 2,713,201 PLESCH. This known assembly comprises an upper clamping plate of curved cross-section, a first razor blade, an intermediate plate of curved cross-section, a second razor blade, a lower clamping plate of curved cross-section and a handle. The upper clamping plate has a central threaded pin and two locating pins arranged laterally of the threaded pin, wherein the threaded pin and the locating pins extend through each a set of corresponding holes formed in the first and second razor blades, the intermediate plate and the lower clamping plate.

The razor blades are planar thin metal sheets which are bent to their curved state by means of the curved surfaces of the upper clamping plate, the intermediate plate′ and the lower clamping plate when the razor device is assembled. A drawback of these known razor blades is that they must be very thin and that due to the holes in the thin metal sheets for receiving the threaded pin and the locating pins the razor blades have an un-homogeneous resistance against bending and/or torsion so that the razor blades may become non-uniformly bent along their length when the razor device is assembled and/or when in use resulting in slightly curved or even corrugated cutting edges.

### BRIEF SUMMARY OF THE INVENTION

It is therefore an object of the invention to provide a razor blade assembly including razor blades the cutting edges of which remain firmly straight when the razor blade assembly is assembled and when in use.

The invention solves the posed problem with a razor blade assembly comprising the features of claim 1 and with a razor blade for a razor blade assembly comprising the features of claim 18.

The advantages of the razor blade assembly according to the invention can essentially be seen therein that:
the pre-curved manufacturing permits a configuration of the razor blades with a narrow width and a higher thickness. Thinner blades are too flexible while thicker blade stay firm. Furthermore, the narrow razor blades and the structure of the assembly as a whole enables easier and more comfortable reach of tight areas on face such as under the nose and around the upper and lower lips;
the thickness of the curved blades enables sharper angle, sharper cut and much longer use. It would be difficult to make the curve to the specifications of the invention when inserting two flat razor blades onto the shaving device like in a traditional Double Edge Safety Razor;
due to the fact that the razor blades are manufactured with a curved state the razor blades do not have to be bent when the razor device is assembled and thus can have an enhanced thickness resulting in an improved rigidity of the razor blades. Therefore, the razor blades have a higher resistance against bending and/or torsion and will not deform in an undesired manner when the razor blade assembly is assembled and/or when in use;
in addition, the achieved angle of cut will make this blade smoother on the skin. Because of that principal, the sharpness, blade longevity, smoothness and quality of shave are superior;
due to the enhanced rigidity of the razor blades the latter do not have to be clamped by ribs extending along the entire length of the razor blades and transverse grooves having a large cross-sectional area giving maximum rinse floatation and maximum drainage simultaneously may be provided between the upper plate, the first razor blade, the spacer member, the second razor blade and the lower plate; and
the cutting edges of the razor blades can be manufactured, e.g. by grinding before or after bending of the metal sheet.

Further advantageous embodiments of the invention can be commented as follows:

In a special embodiment the radius of curvature of the first razor blade is different from the radius of curvature of the second razor blade.

Preferably, the radius of curvature of the second razor blade is equal to 82-92%, preferably to 84-90% and typically 87%, of the radius of curvature of the first razor blade.

In another embodiment the radius of curvature of the first razor blade is in the range of 15.5 mm-17.5 mm, preferably in the range of 16.3 mm to 16.6 mm. A typical value is 16.5 mm.

In a further embodiment the radius of curvature of the second razor blade is in the range of 13.5 mm-15.5 mm, preferably in the range of 14.1 mm-14.4 mm. A typical value is 14.3 mm.

By means of the above dimensions both blades end up having the same angle when pre-curved. Because the second razor blade is wider (e.g. 12 mm) it needs to be curved in more than the first razor blade (e.g. 9.4 mm) that is narrower and needs to be “curved in” less to achieve the same angle of the second lower one. This is why the second razor blade has a smaller radius than the first razor blade.

In a further embodiment the first razor blade and the second razor blade have a fixed position in the horizontal plane after assembly.

In again a further embodiment the ratio WB1/WB2 of the width WB1 of the first razor blade to the width WB2 of the second razor blade is in the range 0.8 to 0.86. A typical value is 0.83.

In another embodiment the upper plate, the lower plate and the spacer member are provided with three-dimensional vertical protuberances running in direction to the razor blades and generating a plurality of channels between the upper plate and the first razor blade; between the first razor blade and the curved spacer member; between the curved spacer member and the second razor blade; and between the second razor blade and curved lower plate. The channels facilitate the flushing, cleaning and rinsing of the razor blade assembly. This configuration has the advantages that the cleaning and rinsing is more efficient and easier compared to prior art devices. The channels or grooves enable open space for rinsing floatation to pass through. It gives more rinsing space for soap, hair and skin accumulations to clear out rather than accumulate and clog up the blades from doing their job.

In another embodiment the three-dimensional vertical protuberances of the upper and lower plates are in the form of isles with a width WI<0.5 WU, respectively WL and a free front surface for contacting the razor blades which is circular cylindrical to conform to the curvature of the razor blades upon assembly of the razor blade assembly.

Preferably, the vertical height of the channels in the upper and lower plates is in the range of 1.25 mm to 1.6 mm and in the spacer member in the range of 0.25 to 0.35 mm. This range of heights permits the advantage of giving the best results for rinsing flow bound by the maximum height allowed for the device.

In another embodiment the channels in the upper and lower plates have a cross-sectional area in the range of 6.5 mm² to 23.0 mm².

In again another embodiment the channels in the spacer member have a cross-sectional area in the range of 1.15 mm² to 2.0 mm².

In a further embodiment the length of the channels in the upper plate is in the range of 5.2 mm to 11.5 mm, in the spacer member in the range of 4.0 mm to 6.9 mm and in the lower plate in the range of 7.0 to 14.7 mm.

In a further embodiment the upper plate comprises two or more guide posts extending vertically from the lower surface, wherein the two or more guide posts extend through corresponding holes in the first razor blade, the spacer member the second razor blade and the lower plate to align all components.

In another embodiment the upper plate comprises a center threaded post extending vertically from the lower surface, wherein the center threaded post extends through the first razor blade, the spacer member, the second razor blade and beyond the lower plate so as to be attachable to a handle.

In another embodiment the two or more guide posts and the center threaded post are equally spaced along the length LU of the upper plate.

In again another embodiment the first and second razor blades comprise tabs or wings arranged at the small sides of the first and second razor blades. Therewith the advantage can be achieved that the tabs or wings form handles allowing a user to safely insert the blade onto the razor blade assembly without fear of cutting ones fingers on the edges of the blade.

In a special embodiment of the razor blade according to the invention the radius of curvature of the razor blade is in the range of 13.5 mm-17.5 mm.

In a further embodiment of the razor blade according to the invention the thickness T1 of the first razor blade and the thickness T2 of the second razor blade is at least 0.45 mm, preferably at least 0.5 mm.

In another embodiment of the razor blade according to the invention the razor blade comprises tabs or wings arranged at the small sides of the razor blade.

### A BRIEF DESCRIPTION OF THE DRAWINGS

Several embodiments of the invention will be described in the following by way of example and with reference to the accompanying drawings in which:

FIG. 1 illustrates an exploded perspective view of an embodiment of the razor blade assembly according to the invention;

FIG. 2a illustrates a top view of a lower razor blade the embodiment of the razor blade assembly of FIG. 1;

FIG. 2b illustrates a front elevation of the lower razor blade the embodiment of the razor blade assembly of FIG. 1;

FIG. 2c illustrates a side view of the lower razor blade the embodiment of the razor blade assembly of FIG. 1;

FIG. 3a illustrates a top view of an upper razor blade the embodiment of the razor blade assembly of FIG. 1;

FIG. 3b illustrates a front elevation of the upper razor blade the embodiment of the razor blade assembly of FIG. 1;

FIG. 3c illustrates a side view of the upper razor blade the embodiment of the razor blade assembly of FIG. 1;

FIG. 4 illustrates a perspective view of the embodiment of the razor blade assembly of FIG. 1 when attached to a handle;

FIG. 5 illustrates a side view of the embodiment of the razor blade assembly of FIG. 1 when attached to a handle;

FIG. 6 illustrates a front elevation of the embodiment of the razor blade assembly of FIG. 1 when attached to a handle;

FIG. 7 illustrates a schematic side view of the embodiment of the razor blade assembly of FIG. 1;

FIG. 8 illustrates a side view of the embodiment of the razor blade assembly of FIG. 1 when attached to a handle and when in use;

FIG. 9 illustrates a diagrammatic exploded front view of the embodiment of the razor blade assembly of FIG. 1;

FIG. 10 illustrates an exploded perspective view of a second embodiment of the razor blade assembly according to the invention;

FIG. 11 illustrates an exploded perspective view of a third embodiment of the razor blade assembly according to the invention;

FIG. 12 illustrates a perspective view of the embodiment of the razor blade assembly of FIG. 11 when attached to a handle; and

FIG. 13 illustrates a front elevation of the embodiment of the razor blade assembly of FIG. 11 when attached to a handle.

### DETAILED DESCRIPTION OF THE INVENTION

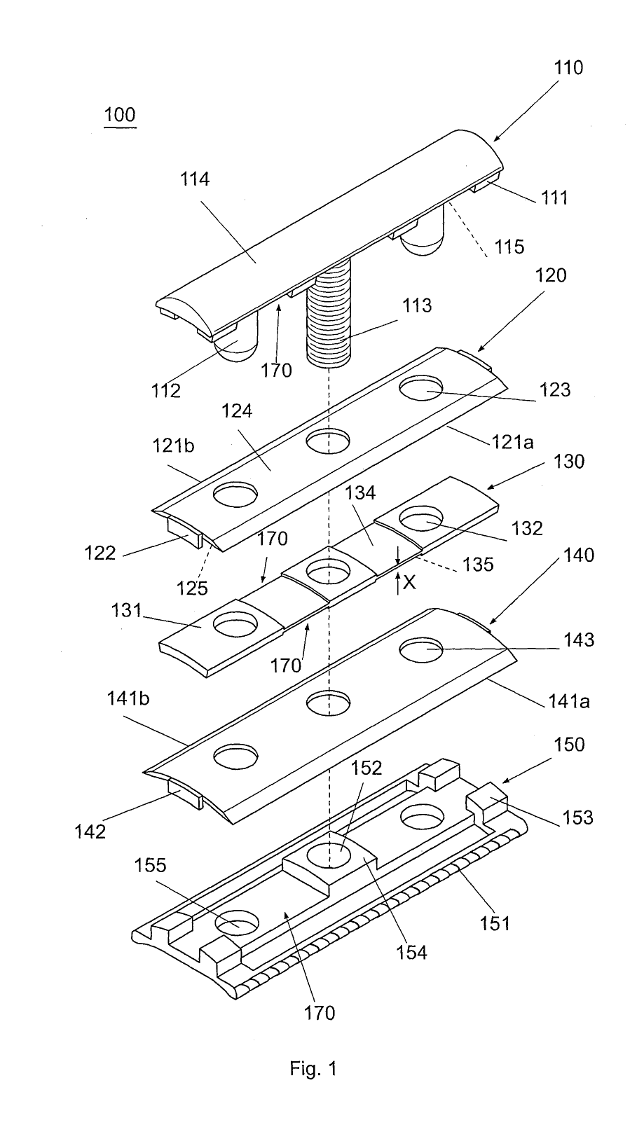

FIGS. 1-9 illustrate a first embodiment of the razor blade assembly 100 according to the invention which comprises at least an upper plate 110, a first razor blade 120, a spacer member 130, a second razor blade 140 and a bottom plate 150.

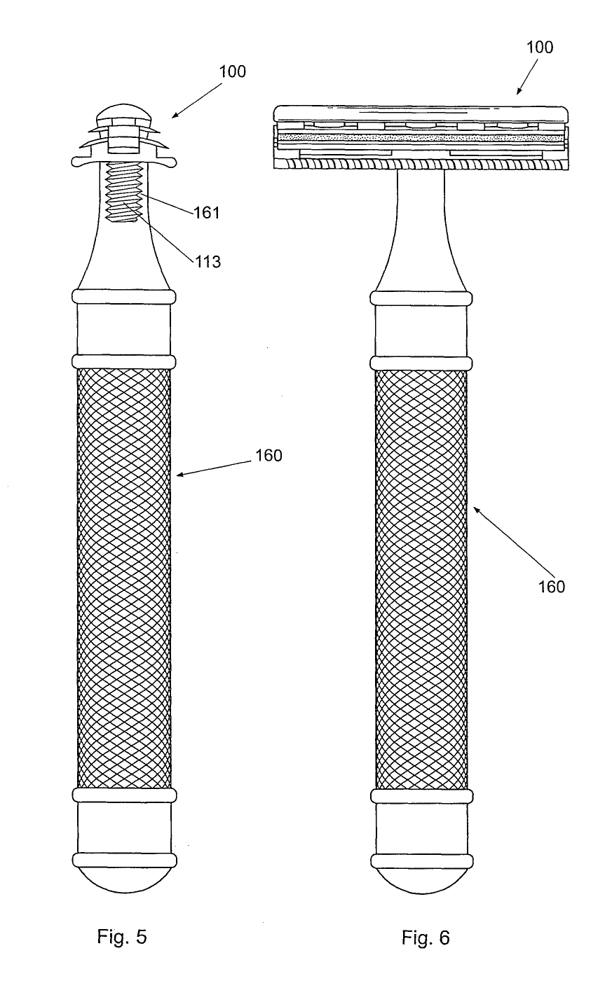

The upper plate 110 comprises a curved upper surface 114, two guide posts 112 spaced on the ends of the plate and a center threaded post 113. The center threaded post 113 is designed to thread into a complementary receptacle 161 in the handle 160 (FIG. 5). The lower surface 115 of the upper plate 110 is also curved but has a greater radius than the curve of the upper surface 114. Attached to the lower surface 115 are multiple spacers 111 which are generally square or rectangular in shape. The multiple spacers 111 are positioned at least on the corners of the upper plate 110 and approximately ⅓ the distance of the length of the plate in from the opposing ends of the upper plate 110. The spacers 111 provide a space between the lower surface 115 of the upper plate 110 and the upper surface 124 of the first razor blade 120. This space allows for cleaning of the razor blade assembly such that water can pass between the upper plate 110 and the first razor blade 120. The upper plate 110 also includes 2 guide posts 112 which extend through the first razor blade 120, the spacer member 130, the second razor blade 140 and the lower plate 150 to ensure the components remain aligned. The threaded post 113 similarly extends through the first razor blade 120, the spacer member 130, the second razor blade 140 and the lower plate 150 and attaches to the handle 160 (FIG. 5), ensuring the components of the razor blade assembly 100 remain assembled.

The first razor blade comprises cutting edges 121a,b along the outer edges of the length of the blade, tabs or wings 122 and 3 equally spaced (along the length of the blade) holes 123. The first razor blade 120 is curved along the length of the blade. The curvature is approximately equivalent to the curve of the lower surface 115 of the upper plate 110. The tabs or wings 122 allow a user to safely insert the blade onto the razor blade assembly without fear of cutting ones fingers on the edges of the blade. The width of the first razor blade 120 is slightly narrower than the width of the second razor blade 140.

The spacer member 130 is similarly curved along the length and corresponds to the curvature of the first razor blade 120. Similar to the first razor blade 120, the spacer member has 3 equally spaced holes 132. The spacer member has a thickness of X. However, the thickness of the spacer member 130 about the holes 132 is greater than X. This allows for channels 170 between the lower surface 125 of the first razor blade 120 and upper surface 134 of the spacer member 130 to facilitate cleaning of the razor blade assembly. The thickness of the spacer member 130 about the holes 132 is such that this area is raised above the upper surface 134 of the spacer member 130 as well as on the lower surface 135 of the spacer member 130, such that channels 170 are formed between the first razor blade 120 and the spacer 130 and the second razor blade 140 and the spacer member 130.

The second razor blade 140 is similar to the first razor blade 120, however it is slightly wider than the first razor blade 120. The second razor blade 140 comprises cutting edges 141a,b along the outer edges of the length of the blade, tabs or wings 142 and 3 equally spaced (along the length of the blade) holes 143. The second razor blade 140 is curved along the length of the blade. The curvature is approximately equivalent to the curve of the lower surface 135 of the spacer member 130. The tabs or wings 142 allow a user to safely insert the blade onto the razor blade assembly without fear of cutting ones fingers on the edges of the blade.

The tabs or wings 122, 142 form handles that are arranged at the small sides of the first and second razor blades 120, 140 and protrude from the respective lower surface.

The lower plate 150 supports the above-mentioned components. Similar to the upper plate 110, the lower plate 150 is curved along the length of the plate. The outer edges 151 of the lower plate 150 are ribbed and come in contact with the face of the user. The ends of the lower plate 150 have spacers 153 that are curved or angled to support the second razor blade 140. Similarly, the area 154 around the center hole 152 is similarly raised to support the second razor blade 140 as well as provide space for cleaning the razor blade assembly. The upper surface of the spacers 153 and the area 154 around the center hole are curved or angled to conform to the curvature of the second razor blade 140.

Furthermore, the upper plate 110, the lower plate 150 and the spacer member 130 are provided with three-dimensional vertical protuberances running in direction to the razor blades 120, 140. These vertical protuberances form spacers 111, 131, 153 which generate a plurality of channels 170, wherein the channels 170 between the upper plate 110 and the first razor blade 120 are generated by the spacers 111 extending from the lower surface 115 of the upper plate 110, the channels 170 between the first razor blade 120 and the curved spacer member 130 are generated by spacers 131 extending from the upper surface 134 of the curved spacer member 130, the channels 170 between the curved spacer member 130 and the second razor blade 140 are generated by spacers 131 extending from the lower surface 135 of the curved spacer member 130 and the channels 170 between the second razor blade 140 and the lower plate 150 are generated by spacers 153 extending the upper surface of the lower plate 150. The channels 170 or grooves enable open space for rinsing floatation to pass through to thereby facilitating the flushing, cleaning and rinsing of the razor blade assembly 100.

These three-dimensional vertical protuberances are in the form of isles with a width WI<0.5 WU, respectively WL in the case of the upper and lower plates 110, 150 and extending over the entire width WS in the case of the curved spacer member 130. Furthermore, the vertical protuberances comprise a free front surface for contacting the razor blades 120, 140 which is circular cylindrical to conform to the curvature of the razor blades 120, 140 upon assembly of the razor blade assembly.

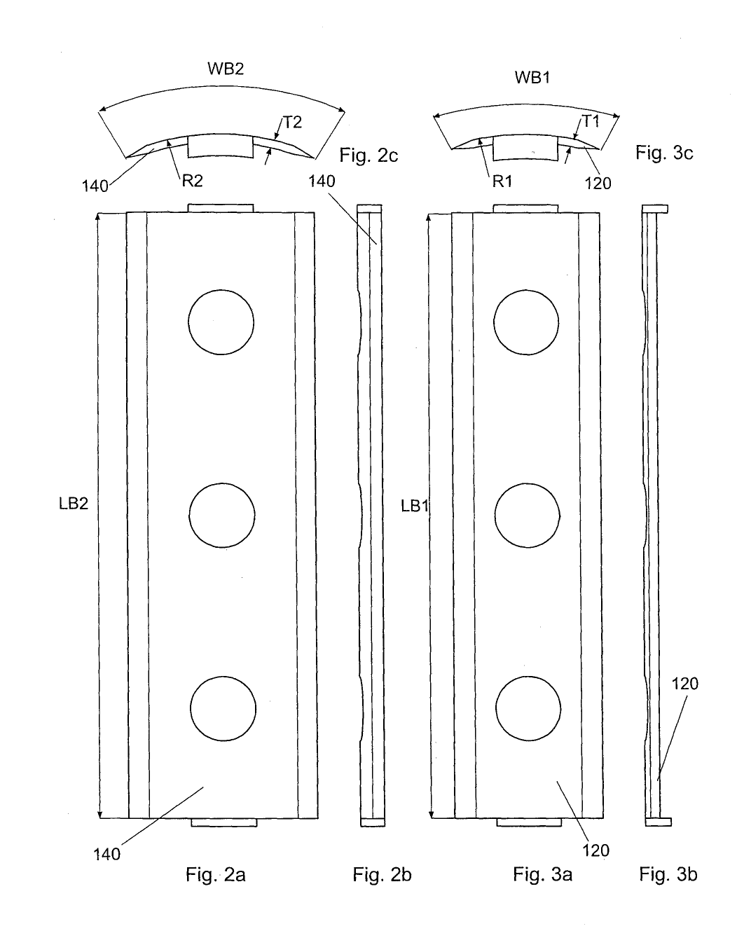

As best seen in FIGS. 2c, 3c and 7, the assembled razor blade assembly 100 comprises in sequence:

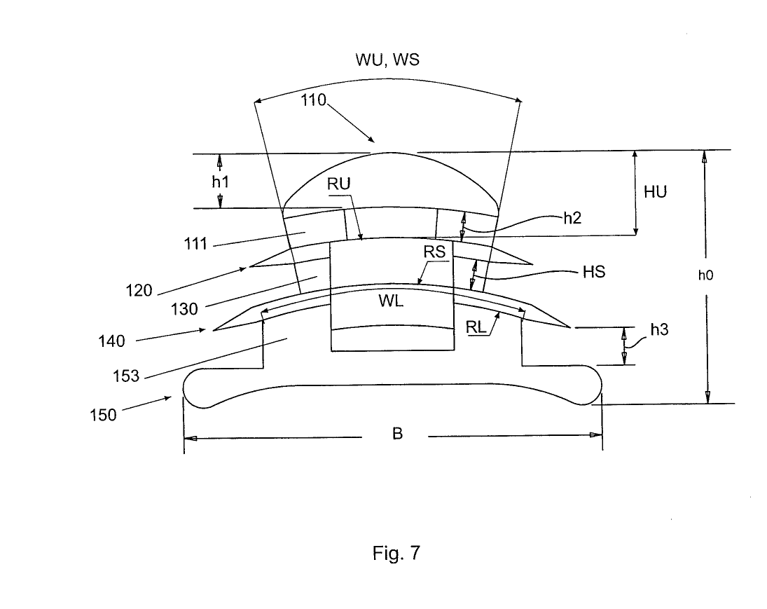

(i) an upper plate 110 of the length LU, the width WU<LU, the height HU and a curvature along the width WU with a radius of curvature RU, the width WU being the length of the arc extending between the outermost edges of the free front surface of the spacers 111 and the radius of curvature RU is measured at the free front surface of the spacers 111 which contacts the first razor blade 120 (FIG. 7);

(ii) a first razor blade 120 of the length LB1, the width WB1<LB1, the thickness T1 and a radius of curvature R1 measured at the upper surface 124 (FIGS. 2a-2c);

(iii) a curved spacer member 130 of the length LS; the width WS<LS, the height HS and a curvature along the width WS with a radius of curvature RS, the width WS being the length of the arc extending between the outermost edges of the lower free front surface of the spacers 131 and the radius of curvature RS measured at the lower free front surface of the spacers 131 which contacts the second razor blade 140 (FIG. 7);

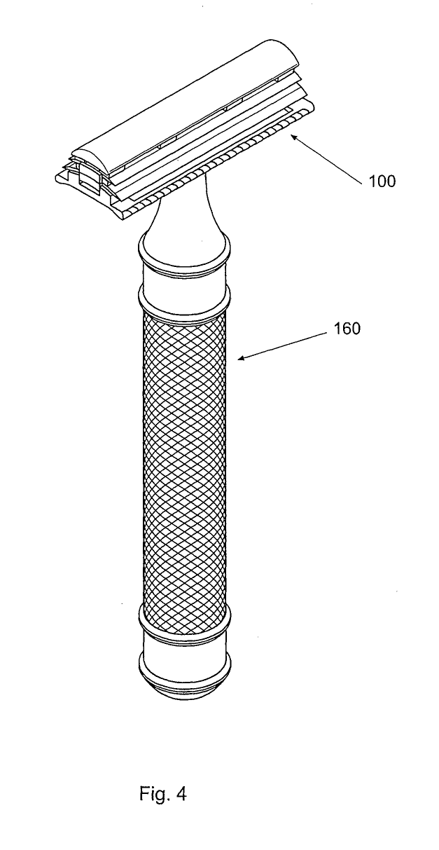

(iv) a second razor blade 140 of the length LB2, the width WB2<LB2, the thickness T2 and a radius of curvature R2 measured at the upper surface (FIGS. 3a-3c); and

(v) a lower plate 150 of the length LL, the width WL<LL, the height HL and a curvature along the width WL with a radius of curvature RL, the width WL being the length of the arc extending between the outermost edges of the upper free front surface of the spacers 153 and the radius of curvature RL measured at the upper free front surface of the spacers 153 which contacts the second razor blade 140 (FIG. 7).

The first razor blade 120 and the second razor blade 140 have a generally rectangular shape and comprise a front cutting edge 121a,141a running lengthwise and a rear cutting edge 121b,141b running lengthwise. Furthermore, the first and second razor blades 120,140 in its unloaded state are curved in a cross-sectional plane orthogonal to the cutting edges, wherein the radius of curvature of the first razor blade 120 is different from the radius of curvature of the second razor blade 140.

As illustrated in FIGS. 5 and 6 the elements (i) to (v) can be reversibly assembled and mounted vertically in height on a razor handle 160.

Exemplarily but not limiting the first and second razor blades 120, 140 can have the below dimensions:

| First razor blade 120 | Second razor blade 140 |
|---|---|
| LB1 = 38 mm | LB2 = 38 mm |
| WB1 = 9.4 mm | WB2 = 12 mm |
| T1 = 0.50 mm | T2 = 0.50 mm |
| R1 = 16.5 mm | R2 = 14.3 mm |

The first and second razor blades 120, 140 end up having the same angle when pre-curved. Because the second razor blade 140 is wider (WB2=12 mm) it needs to be curved in more than the first razor blade 120 (WB1=9.4 mm) that is narrower and needs to be “curved in” less to achieve the same angle of the lower one. Therefore, the second razor blade 140 has the smaller radius than the first razor blade 120.

In FIG. 7 the following table additional dimensions of the razor blade assembly 100 are indicated which are exemplary and not limiting:

| | |
|---|---|
| Overall height h0 | 8.33 mm |
| Thickness h1 of the upper plate 110 (measured | 1.77 mm |
| from the vertex to the bottom of the channels 170) | |
| Height h2 of the spacers 111 (measured from the | 1.0 mm |
| bottom of the channels 170 to the free front | |
| surface) | |
| Spacing h3 (measured between the cutting edges | 1.24 mm |
| 141a, b of the second razor blade 140 and the top | |
| surface of the lower portion of the lower plate 150) | |
| Height HS of the spacer member 130 | 1.0 mm |
| Width B of the lower portion of the lower plate 150 | 13.64 mm |

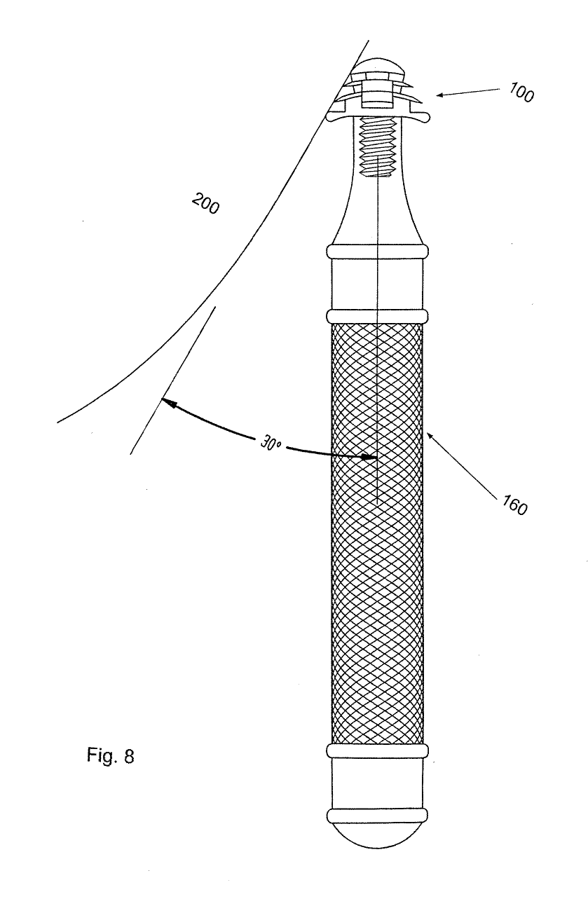

As illustrated in FIG. 8 the dimensions of the upper plate 110, the first razor blade 120, the curved spacer member 130, the second razor blade 140 and the lower plate 150 are selected to permit the razor blade assembly 100 to enable a favorable angle of 30° between a vertical axis of the razor blade assembly 100 and the face 200 of the user.

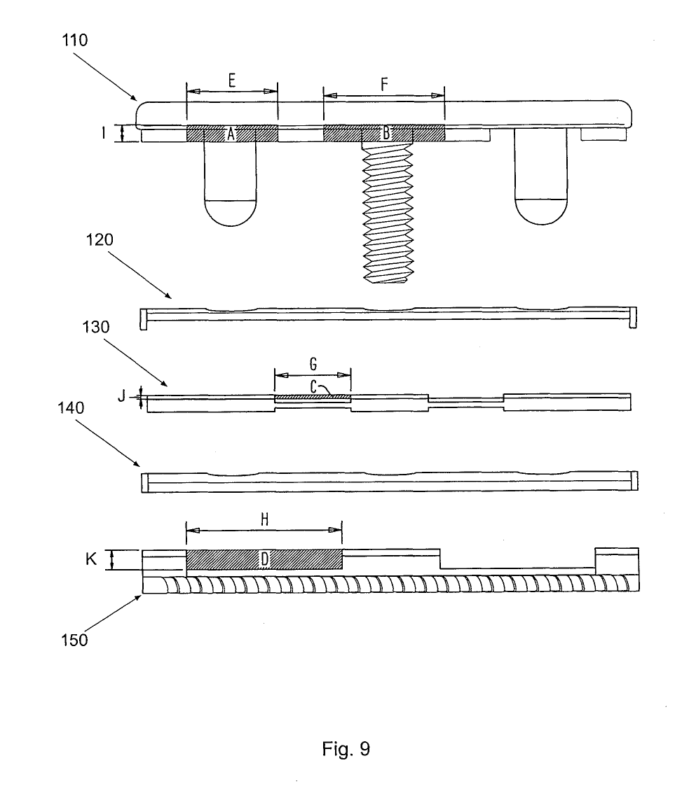

In FIG. 9 the following table additional dimensions of the channels 170 (cross-sectional areas A-D, lengths E-H and heights I-K) generated by the vertical protuberances in the form of the spacers 111, 131, 153 are indicated which are exemplary and not limiting:

| | Typical | Minimum | Maximum |
|---|---|---|---|
| A | 9.44 mm² | 6.92 mm² | 11.44 mm² |
| B | 12.79 mm² | 9.58 mm² | 15.30 mm² |
| C | 1.73 mm² | 1.16 mm² | 2.00 mm² |
| D | 18.89 mm² | 10.85 mm² | 22.79 mm² |
| E | 7.10 mm | 5.20 mm | 8.60 mm |
| F | 9.62 mm | 7.20 mm | 11.50 mm |
| G | 5.97 mm | 4.00 mm | 6.90 mm |
| H | 12.19 mm | 7.00 mm | 14.70 mm |
| I | 1.33 mm | | |
| J | 0.29 mm | | |
| K | 1.55 mm | | |

As best seen in FIG. 1 the upper plate 110 comprises two guide posts 112 extending vertically from the lower surface 115, wherein the two or more guide posts 112 extend through corresponding holes 123,132,143,155 in the first razor blade 120, the spacer member 130, the second razor blade 140 and the lower plate 150 to align all components. Furthermore, the upper plate 110 comprises a center threaded post 113 extending vertically from the lower surface 115, wherein the center threaded post 113 extends through corresponding holes 123, 132, 143 in the first razor blade 120, the spacer member 130 and the second razor blade 140 and beyond the lower plate 150 through a center hole 152 in the lower plate 150 so as to be attachable to a handle 160 (FIG. 5). The two guide posts 112 and the center threaded post 113 are equally spaced along the length LU of the upper plate 110.

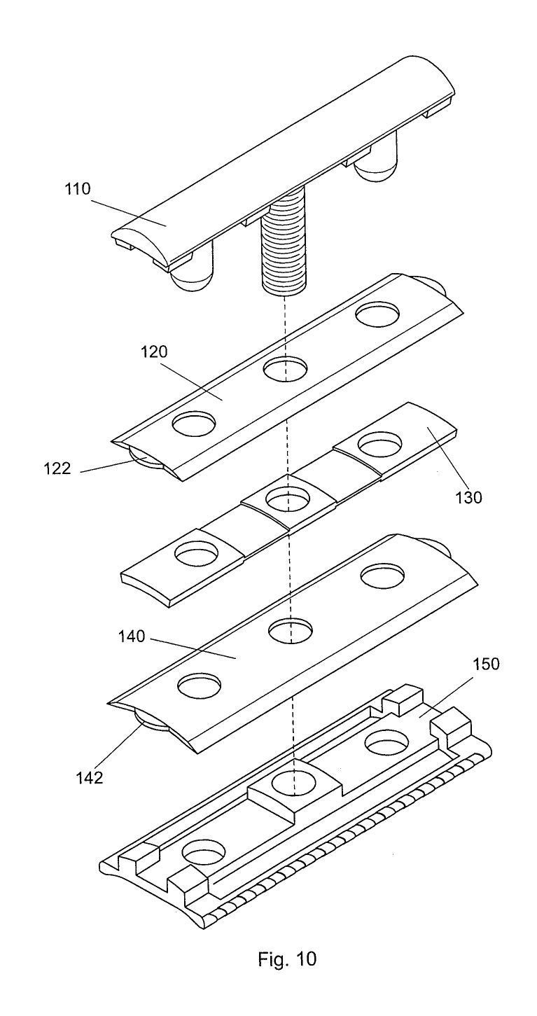

FIG. 10 illustrates a second embodiment of the razor blade assembly 100 according to the invention which differs from the embodiment of FIGS. 1-9 only therein that the handles in the form of tabs or wings 122, 142 of the first and second razor blades 120, 140 are shaped differently, namely the tabs or wings 122, 142 are rounded and flattened outwards.

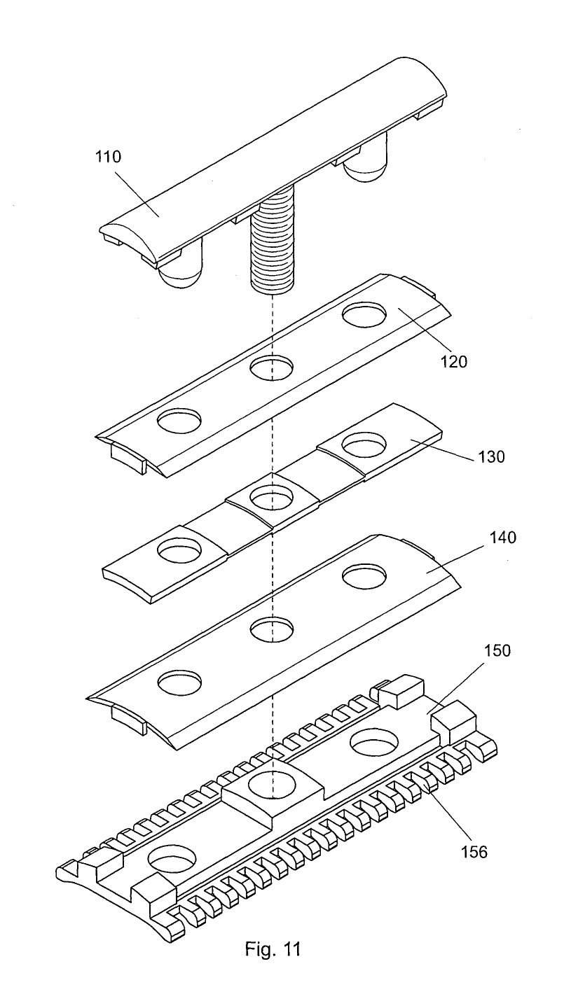

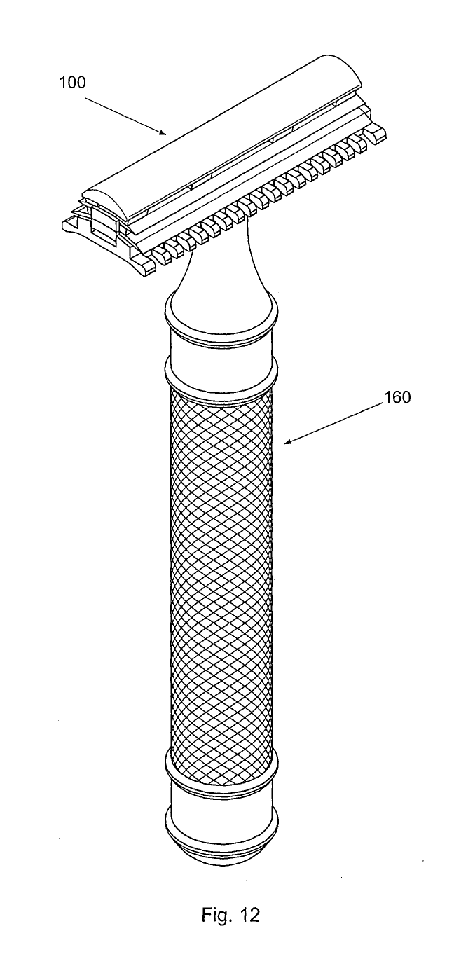

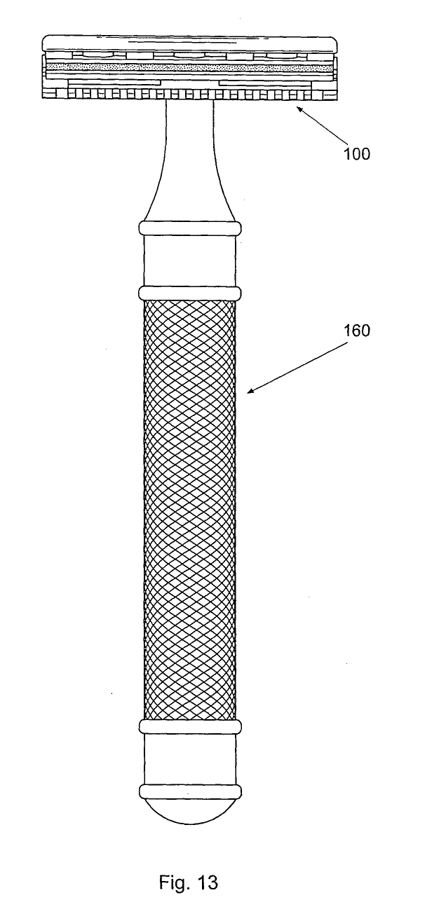

FIGS. 11-13 illustrate a third embodiment of the razor blade assembly 100 according to the invention which differs from the embodiment of FIGS. 1-9 only therein that the long sides of the lower portion of the lower plate 150 comprise recesses 156 that are equally spaced along the long sides so as to form an open comb.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

1. A razor blade assembly, comprising, in sequence, elements:
(i) an upper plate having a length LU, a width WU<LU, a height HU and a curvature along the width WU with a radius of curvature RU;
(ii) a first razor blade having a length LB1, a width WB1<LB1 and a thickness T1;
(iii) a curved spacer member having a length LS; a width WS<LS, a height HS and a curvature along the width WS with a radius of curvature RS;
(iv) a second razor blade having a length LB2, a width WB2<LB2 and a thickness T2; and
(v) a lower plate having a length LL, a width WL<LL, a height HL and a curvature along the width WL with a radius of curvature RL;
wherein:
a) the elements (i) to (v) are reversibly assemblable and mountable vertically in height on a razor handle;
b) the first razor blade and the second razor blade each have a generally rectangular shape and each comprise a front cutting edge running lengthwise and a rear cutting edge running lengthwise;
c) the first and second razor blades in an unloaded state each are curved in a cross-sectional plane orthogonal to the front and rear cutting edges;
d) the thickness T1 and T2 of the first and second razor blades is at least 0.45 mm; and
e) the upper plate, the lower plate and the spacer member are provided with protuberances that generate a plurality of channels in the upper plate, the lower plate and the spacer member, said channels facilitating flushing, cleaning and rinsing of the razor blade assembly between:
1) the upper plate and the first razor blade;
2) the first razor blade and the curved spacer member;
3) the curved spacer member and the second razor blade; and
4) the second razor blade and curved lower plate.

2. The razor blade assembly according to claim 1, wherein the radius of curvature of the first razor blade is different from the radius of curvature of the second razor blade.

3. The razor blade assembly according to claim 2, wherein the radius of curvature of the second razor blade is equal to 82-92%, of the radius of curvature of the first razor blade.

4. The razor blade assembly according to claim 1, wherein the radius of curvature of the first razor blade is in a range of 15.5 mm-17.5 mm.

5. The razor blade assembly according to claim 1, wherein the radius of curvature of the second razor blade is in a range of 13.5 mm-15.5 mm.

6. The razor blade assembly according to claim 1, wherein the first razor blade and the second razor blade have a fixed position in a horizontal plane after assembly.

7. The razor blade assembly according to claim 1, wherein a ratio WB1/WB2 of the width WB1 of the first razor blade to the width WB2 of the second razor blade is in a range 0.8 to 0.86.

8. (canceled)

9. The razor blade assembly according to claim 1, wherein the protuberances of the upper and lower plates are in a form of isles with a width WI<0.5 WU, WL and a free front surface for contacting the razor blades which is circular cylindrical to conform to the curvature of the razor blades upon assembly of the razor blade assembly.

10. The razor blade assembly according to claim 1, wherein a vertical height of the channels in the upper and lower plates is in a range of 1.25 mm to 1.6 mm and in the spacer member in a range of 0.25 to 0.35 mm.

11. The razor blade assembly according to claim 1, wherein the channels in the upper and lower plates have a cross-sectional area in a range of 6.5 mm² to 23.0 mm².

12. The razor blade assembly according to claim 1, wherein the channels in the spacer member have a cross-sectional area in a range of 1.15 mm² to 2.0 mm².

13. The razor blade assembly according to claim 1 wherein a length of the channels in the upper plate is in a range of 5.2 mm to 11.5 mm, a length of the channels in the spacer member is in a range of 4.0 mm to 6.9 mm and a length of the channels in the lower plate is in a range of 7.0 to 14.7 mm.

14. The razor blade assembly according to claim 1, wherein the upper plate comprises two or more guide posts extending vertically from a lower surface of the upper plate, wherein the two or more guide posts extend through corresponding holes in the first razor blade, the spacer member, the second razor blade and the lower plate to align elements (i) through (v).

15. The razor blade assembly according to claim 14, wherein the upper plate comprises a center threaded post extending vertically from a lower surface of the upper plate, wherein the center threaded post extends through the first razor blade, the spacer member, the second razor blade and beyond the lower plate so as to be attachable to the razor handle.

16. The razor blade assembly according to claim 15, wherein the two or more guide posts and the center threaded post are equally spaced along the length LU of the upper plate.

17. The razor blade assembly according to claim 1, wherein the first and second razor blades comprise tabs or wings arranged at small sides of the first and second razor blades.

18. A razor blade for a razor blade assembly, wherein
a) the razor blade has a generally rectangular shape, a length, a width, and a thickness, and comprises:
a front cutting edge running lengthwise; and
a rear cutting edge running lengthwise;
b) the razor blade in an unloaded state is curved in a cross-sectional plane orthogonal to the front and rear cutting edges; and
c) a radius of curvature of the razor blade is in a range of 13.5 mm-17.5 mm.

19. (canceled)

20. The razor blade according to claim 18, wherein the thickness is at least 0.45 mm.

21. The razor blade according to claim 18, wherein the razor blade comprises tabs or wings arranged at the small sides of the razor blade.
